(19) United States
(12) Patent Application Publication
(10) Pub. No.: US 2009/0269066 A1
(43) Pub. Date: Oct. 29, 2009

(54) Single-Unit Integrated Transceiver Having Pump Source and Transceiver Module Using the Same

(76) Inventors: Mun-Seob Lee, Daejeon-city (KR); Jong-Deog Kim, Gwangju-city (KR); Byung-Tak Lee, Gyeonggi-do (KR); Dong-Soo Lee, Gwangju-city (KR); Hark Yoo, Gwangju-city (KR); Sung-Woong Park, Gyeonggido (KR); Bin-Yeong Yoon, Daejeon-city (KR); Bong-Tae Kim, Daejeon-city (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/298,491

(22) PCT Filed: Apr. 24, 2007
(86) PCT No.: PCT/KR2007/001998

§ 371 Date: Mar. 20, 2009

(30) Foreign Application Priority Data
Apr. 26, 2006 (KR) 10-2006-0037759

(51) Int. Cl. H04J 14/02; H04J 14/00

(52) U.S. Cl. 398/79; 398/43; 398/138

(57) ABSTRACT

Provided are a sing-unit integrated transceiver having a pump source and a transceiver module using the transceiver. The single-unit integrated transceiver includes: an optical transmitter converting an input electric signal into a downstream optical signal; an optical receiver converting a received upstream optical signal into an electric signal; the pump source amplifying the downstream or upstream optical signal using a gain medium positioned in an optical transmission line to amplify an output optical signal; a convergence unit arranging or converging the downstream and upstream optical signals to/from the optical transmission line; and a multiplexing and/or a demultiplexing filter, the multiplexing filter positioned on an optical path between the optical transmitter/pump source and the convergence unit, and multiplexing the downstream optical signal and the amplified optical signal to pass to the convergence unit, the demultiplexing filter positioned on an optical path between the convergence unit and the optical receiver and demultiplexing the upstream optical signal to pass to the optical receiver.

### TECHNICAL FIELD

The present invention relates to a single-unit integrated transceiver having a pump source and a transceiver module using the same, and more particularly, to a single-unit integrated transceiver having a pump source and a light source generating an optical signal containing data and a transceiver module using the same.

### BACKGROUND ART

The amount of data transmitted using optical fibers in subscriber networks is increasing due to increases in data demands of data transmissions such as high picture quality broadcasting or games.

Current subscriber networks use speeds from several Mbps to tens of Mbps adopting technologies such as digital subscriber line (xDSL) or the like using copper wires and are mainly limited to Internet services.

However, there are required various multimedia services provided in real-time together with high picture quality services such as high definition television (HDTV) multi-channel cable televisions (CATVs), video on demand (VoD), remote education, remote diagnosis and treatment, or 3D video. The xDSL using the copper wires cannot accommodate such services due to a speed limitation and thus require a new subscriber network.

Various methods of constituting the new subscriber network have been suggested. However, a passive optical network (PON) method advantageous in terms of installing and operating costs is the most prominent.

In the PON method, an optical line is shared to lower installation costs, and only passive elements are installed between a telephone office and subscribers to make maintenance and repair easy. Also, it is advantageously easy to provide video services and increase dense wavelength division multiplexing (DWDM).

In particular, optical networks may provide tens to hundreds of megabyte data per second and high picture quality broadcasts having hundreds of channels to subscribers.

FIG. 1 is a view illustrating a structure of an optical network. Referring to FIG. 1, the optical network includes a central office (CO) 110, a number N of optical network terminals (ONTs) 120 through 120-N, optical transmission lines 131 and 133 connecting the optical line terminal 110 to the N ONTs 120 through 120-N, and a remote node 132 allocating downstream optical signals and multiplexing of upstream optical signals.

A transceiver 115 of the optical line terminal 110 includes a light source 112, an optical receiver 114, a filter 111, and a housing 115. The light source 112 provides a downstream optical signal to the N ONTs 120 through 120-N through the remote terminal 132 and the optical transmission lines 131 and 133. The optical receiver 114 receives an upstream optical signal transmitted from the ONTs 120 through 120-N using a time division multiple access (TDMA) or wavelength division multiple access (WDMA) method. The filter 111 multiplexes and/or demultiplexes the upstream optical signal and the downstream optical signal. The housing 115 integrates the light source 112, the optical receiver 114, and the filter 111 into a single unit.

The ONTs 120 through 120-N respectively include filters 121 through 121-N, optical receivers 123 through 123-N, optical transmitters 122 through 122-N, and housings 124 through 124-N. The filters 121 through 121-N multiplex and/or demultiplex the downstream optical signal transmitted from the optical network terminal 110 through the optical transmission lines 131 and 133 and the remote node 132 and upstream optical signals generated by the optical transmitters 122 through 122-N of the optical transceivers 124 through 124-N of the ONTs 120 through 120-N. The optical receivers 123 through 123-N receive downstream optical signals. The optical transmitters 122 through 122-N generate upstream optical signals. The housings 124 through 124-N integrate the filters 121 through 121-N, the optical receivers 123 through 123-N, and the optical transmitters 122 through 122-N into single units.

An optical network having the above-described structure transmits upstream and downstream optical signals having different wavelengths and containing requested data through optical transmission lines. Also, when such an optical network is applied to a cable broadcast optical network, the upstream optical signals may not be used. However, downstream optical transmitters have similar structures.

In the structures of such a general optical network, increases in distances of the optical transmission lines 131 and 133 cause loss of optical signals. Thus, a transmission distance from the optical line terminal 110 to the ONTs 120 through 120-N is limited. Loss caused by allocation of optical signals of the remote node 132 to subscribers results in a limitation of the number of ONTs that can be included.

Thus, semiconductor amplifiers or optical fiber amplifiers are used on optical transmission lines to increase the transmission distance and the number of subscribers that can use a general method.

The use of semiconductor amplifiers comes at a high-price and semiconductor amplifiers require monitoring elements monitoring states of output signals and thus have complicated structures. Advanced technology such as a planar lightwave circuit (PLC) is required to integrate the semiconductor optical amplifiers and the monitoring elements into a single unit. As a result, it is difficult to employ the use of semiconductor optical amplifiers, and cost of manufacturing the semiconductor optical amplifiers increases the overall cost of an optical network.

If optical fiber amplifiers are used, which have very large volumes, the size of the optical system increases. As a result, cost of a network increases.

U.S. Pat. No. 5,574,589, entitled ‘Self-Amplified Network’, discloses a structure in which a gain medium is used in an optical transmission line, and light output from an optical transmitter is used as a pump source for optical pumping, and a light source for data transmission so as to amplify an optical signal advancing in an opposite direction.

However, in this case, wavelengths of downstream and upstream optical signals depend on the gain medium. Thus, generally used wavelengths cannot be used. When a transmission distance increases, an intensity of pump light used as the optical pump must increase. As a result, a high-priced light source is required.

A research paper ‘Remote Amplification in High Density Passive Optical Networks,’ ICTON2005, We.P.9., pp 409-412, details on optical network in which a gain medium is simultaneously used in a remote node and OLTs, a pump source and an optical transmission source are used to amplify an upstream optical signal operating in a burst mode so as to increase a number of network terminals to 8,192.

However, in this structure, a wavelength of the upstream optical signal is 1550 nm. Thus, a high-priced 1550 nm-laser diode (LD) must be used. Also, the use of an erbium doped fiber (EDF) in the remote node causes locking of signals due to amplified spontaneous emission (ASE) in a PON configuration.

### DISCLOSURE OF INVENTION

### Technical Problem

The present invention provides a transceiver having a pump source and a single-unit integrated transceiver module using the transceiver.

### Technical Solution

According to an aspect of the present invention, there is provided a single-unit integrated transceiver having a pump source, including: an optical transmitter converting an input electric signal into a downstream optical signal; an optical receiver converting a received upstream optical signal into an electric signal; the pump source amplifying the downstream or upstream optical signal using a gain medium positioned in an optical transmission line to amplify the input and output optical signals; a convergence unit arranging or converging the downstream and upstream optical signals to/from the optical transmission line; and a multiplexing and/or a demultiplexing filter, the multiplexing filter positioned on an optical path between the optical transmitter/pump source and the convergence unit, and multiplexing the downstream optical signal and the amplified optical signal to pass to the convergence unit, the demultiplexing filter positioned on an optical path between the convergence unit and the optical receiver and demultiplexing the upstream optical signal to pass to the optical receiver.

According to another aspect of the present invention, there is provided a transceiver module having a pump source, including: an optical transmitter converting an input electric signal into a downstream optical signal; an optical receiver converting a received upstream optical signal into an electric signal; the pump source amplifying the downstream or upstream optical signal using a gain medium positioned in an optical transmission line to amplify an output optical signal; a convergence unit arranging or converging the downstream and upstream optical signals on the optical transmission line; and a multiplexing and/or a demultiplexing filter, the multiplexing filter positioned on an optical path between the optical transmitter/pump source and the convergence unit, and multiplexing the downstream optical signal and the amplified optical signal to pass to the convergence unit, the demultiplexing filter positioned on an optical path between the convergence unit and the optical receiver and demultiplexing the upstream optical signal to pass to the optical receiver; and a housing integrating the optical transmitter, the optical receiver, the pump source, the convergence unit, and the multiplexing and/or demultiplexing filter into a single-unit module.

### Advantageous Effects

As described above, according to the present invention, a pump source can be integrated with an optical transmission source or an optical receiver to amplify signals using a gain medium positioned at some point in an optical transmission line. Thus, a number of subscribers and a transmission distance can be increased. As a result, an economical optical subscriber network can be realized.

### DESCRIPTION OF DRAWINGS

FIG. 1 is a diagram illustrating a configuration of a conventional optical network;

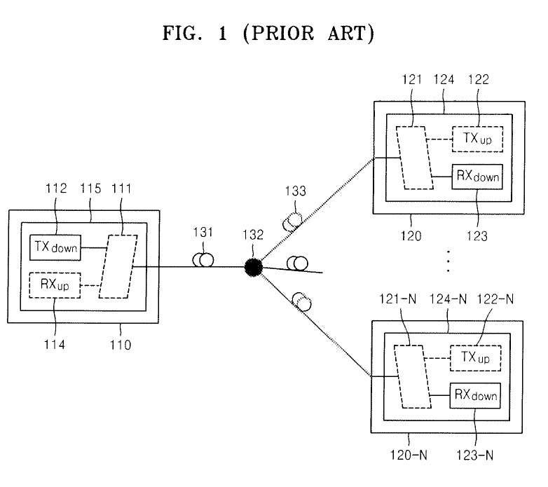

FIG. 2 is a diagram illustrating a configuration of an optical network using a single-unit integrated transceiver with a pump source according to an embodiment of the present invention;

FIG. 3 is a diagram illustrating a configuration of a transceiver module according to an embodiment of the present invention;

FIGS. 4A and 4B are diagrams illustrating an optical transmitter module and an optical receiver module according to embodiments of the present invention;

FIGS. 5A through 5C are diagrams illustrating transceiver, receiver, and transmitter modules according to embodiments of the present invention; and

FIG. 6 is a diagram illustrating a transceiver module according to another embodiment of the present invention.

### BEST MODE

According to an aspect of the present invention, there is provided a single-unit integrated transceiver having a pump source, including: an optical transmitter converting an input electric signal into a downstream optical signal; an optical receiver converting a received upstream optical signal into an electric signal; the pump source amplifying the downstream or upstream optical signal using a gain medium positioned in an optical transmission line to amplify the input and output optical signals; a convergence unit arranging or converging the downstream and upstream optical signals to/from the optical transmission line; and a multiplexing and/or a demultiplexing filter, the multiplexing filter positioned on an optical path between the optical transmitter/pump source and the convergence unit, and multiplexing the downstream optical signal and the amplified optical signal to pass to the convergence unit, the demultiplexing filter positioned on an optical path between the convergence unit and the optical receiver and demultiplexing the upstream optical signal to pass to the optical receiver.

According to another aspect of the present invention, there is provided a transceiver module having a pump source, including: an optical transmitter converting an input electric signal into a downstream optical signal; an optical receiver converting a received upstream optical signal into an electric signal; the pump source amplifying the downstream or upstream optical signal using a gain medium positioned in an optical transmission line to amplify an output optical signal; a convergence unit arranging or converging the downstream and upstream optical signals on the optical transmission line; and a multiplexing and/or a demultiplexing filter, the multiplexing filter positioned on an optical path between the optical transmitter/pump source and the convergence unit, and multiplexing the downstream optical signal and the amplified optical signal to pass to the convergence unit, the demultiplexing filter positioned on an optical path between the convergence unit and the optical receiver and demultiplexing the upstream optical signal to pass to the optical receiver; and a housing integrating the optical transmitter, the optical receiver, the pump source, the convergence unit, and the multiplexing and/or demultiplexing filter into a single-unit module.

### MODE FOR INVENTION

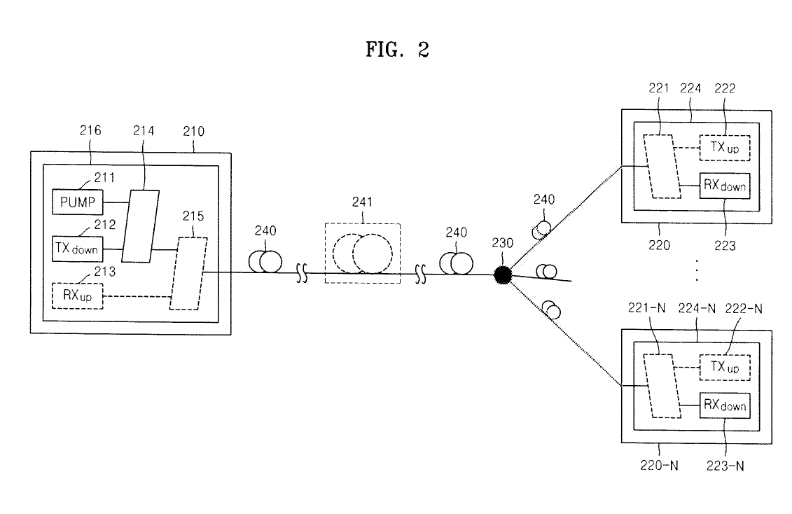

FIG. 2 is a diagram illustrating a configuration of an optical network using a single-unit integrated transceiver having a pump source according to an embodiment of the present invention. Referring to FIG. 2, the optical network includes a central office (CO) 210, a remote node (RN) 230, optical network units (ONUs) 220 through 220-N, and an optical transmission line 240 connecting the ONUs 220 through 220-N to the CO 210.

A single-unit optical transceiver 216 of the CO 210 includes an optical transmitter 212, a pump source 211, a multiplexing filter 214, an optical receiver 213, and a demultiplexing filter 215. The optical transmitter 212 generates a downstream optical signal to be transmitted to the ONUs 220 through 220-N. The pump source 211 amplifies an optical signal using a gain medium 241. The multiplexing filter 214 wavelength multiplexes the optical signal. The optical receiver 213 receives upstream optical signals from the ONUs 220 through 220-N. The demultiplexing filter 215 demultiplexes the downstream optical signal and pump light along with the upstream optical signal.

The optical transmission line 240 may be a general single mode fiber (SMF).

The gain medium 241 may be an optical transmission line, an erbium doped fiber (EDF), a thulium doped fiber (TDF), etc. according to the method of pumping an optical signal employed.

A wavelength of pump light depends on the pumping method employed.

The gain medium 241 may be positioned at any point of an optical signal transmission path or a data signal transmission path through which a downstream optical signal and pump light pass at the same time. In particular, the gain medium 241 may be positioned inside an optical fiber of an optical patch code connected to a single-unit transceiver, a CO, a RN, an ONT, or the like. The gain medium 241 may be manufactured in the form of an optical patch code, a module, or a planar waveguide amplifier (PWA) using a planar lightwave circuit (PLC) technique.

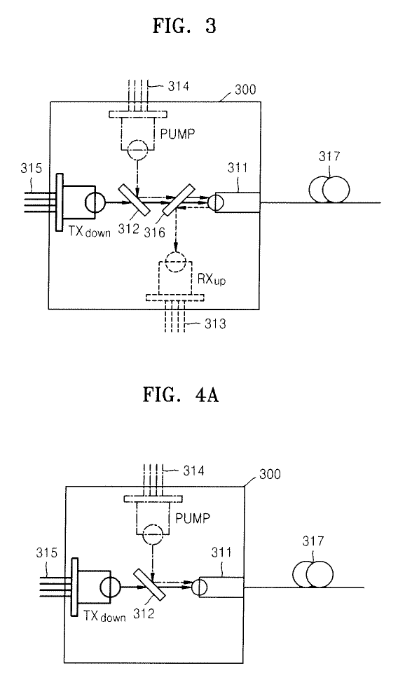

FIG. 3 is a diagram illustrating a configuration of a transceiver module according to an embodiment of the present invention.

A single-unit transceiver having a pump source of the CO may be employed as a two-way triplexer module as shown in FIG. 3.

The characteristics of a transmitter, a receiver, and a pump source as mentioned with reference to FIG. 2 are important. However, methods of integrating the transmitter, the receiver, and the pump source into a compact two-way module are more important.

A performance of the two-way module may depend on a constitution method in terms of technology. The price of the two-way module may be lowered through mass-production.

Referring to FIG. 3, a transceiver module includes a convergence unit (perrule and lens) 311, a pump source 314, an optical transmission source 315, an optical receiver 313, a multiplexing filter 312, a demultiplexing filter 316, and a housing 300. The convergence unit 311 is connected to an external optical fiber. The multiplexing filter 312 is positioned on an optical path between the optical transmission source 315/pump source 314 and the convergence unit 311 to multiplex the downstream optical signal and the amplified optical signal to pass to the convergence unit 311. The demultiplexing filter 316 is positioned on an optical path between the convergence unit 311 and the optical receiver 313 to demultiplex the upstream optical signal to pass to the optical receiver. The housing 300 integrates the convergence unit 311, the pump source 314, the optical transmission source 315, the optical receiver 313, the multiplexing filter 312, and the demultiplexing filter 316 into the transceiver module. The transceiver module may be a triplexer module.

Also, an optical patch code 317 is used to connect the convergence unit 311 to an optical transmission line.

Here, the pump source 314, the optical transmission source 315, and the optical receiver 313 may be used as a sub-assembly having a Top Open Can (TO-CAN) based packaging which may be generally manufactured. Alternatively, the pump source 314, the optical transmission source 315, and the optical receiver 313 may be used as a planar lightwave circuit (PLC) depending on a method of manufacturing a triplexer or a structure combining a thermoelectric cooler (TEC) with a thermister for compensating for temperature changes.

Also, isolators may be used at input and output ports of light sources to reduce interference of optical signals.

The convergence unit 311 may be a lensed fiber to be connected to the external optical fiber.

The optical patch code 317 may be a pigtail or an attachable or detachable optical fiber depending on a shape of the triplexer module 300.

In the single-unit integrated transceiver having the pump source, pump light and a downstream optical signal are amplified as wideband light through a gain medium positioned on a transmission line and then transmitted to ONUs. Also, an upstream optical signal is received through the transmission line.

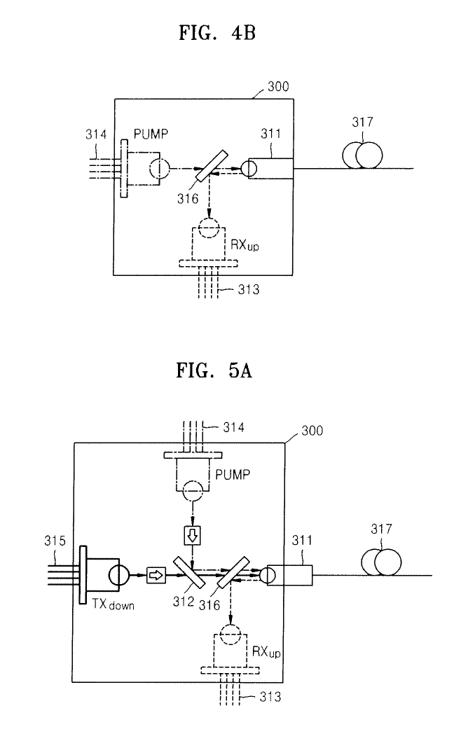

FIGS. 4A and 4B are diagrams illustrating an optical transmitter and an optical receiver according to embodiments of the present invention.

FIG. 4A illustrates an optical transmitter module where a multiplexing filter and an optical receiver are not included.

Such an optical transmitter module may be adopted in an optical subscriber network, a broadcast network, and a wavelength division multiplexing-passive optical network (WDM-PON).

The WDM-PON may communicate light of several channels using an optical fiber, may utilize a bandwidth of an optical element to the maximum, and is highly secure.

An optical element for constituting an optical subscriber network for the WDM-PON requires a light source having a number of wavelengths. The number of wavelengths is equal to a number of subscribers.

Thus, an optical transmission source of a transceiver module of the present invention may be a wavelength variable laser or a distributed feedback-laser diode (DFB-ID) array capable of monitoring a wavelength to be adopted in the WDM-PON.

FIG. 4B illustrates an optical receiver module not having an optical transmitter but having a pump source and an optical receiver to amplify a received optical signal.

The optical receiver module may be adopted in an optical subscriber network, a broadcast network, or a WDM-PON.

In particular, a TDM-based optical subscriber network requires an optical receiver, which has high sensitivity and can operate in a burst mode, to detect signals having different intensities, wherein the signals are respectively transmitted to subscribers.

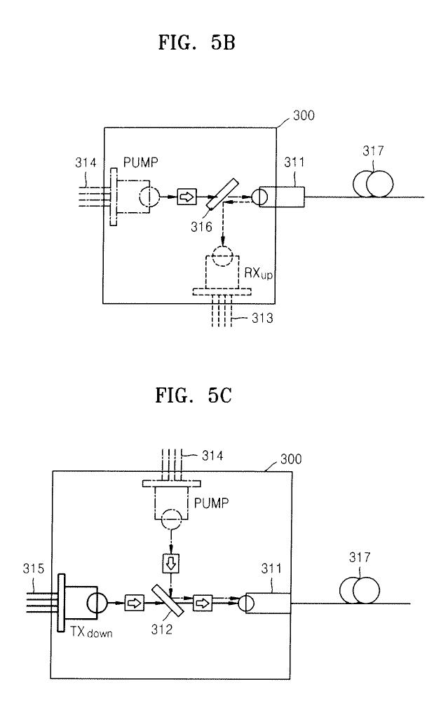

FIGS. 5A through 5C are diagrams illustrating optical transceiver, receiver and transmitter modules according to embodiments of the present invention.

FIGS. 5A through 5C illustrate positions of isolators in the modules. A pump source 314, an optical transmission source 315, and an optical receiver 313 are integrated into a triplexer module. In the triplexer module, backward noise generated from a transmission line or a gain medium connected thereto may be input to the optical transmission source 315 and the pump source 314. Thus, in the current embodiment, isolators are installed to prevent the backward noise from affecting output characteristics of an optical signal or pump light.

In this case, the isolator in front of the pump source may not be used depending on a used wavelength of the pump source.

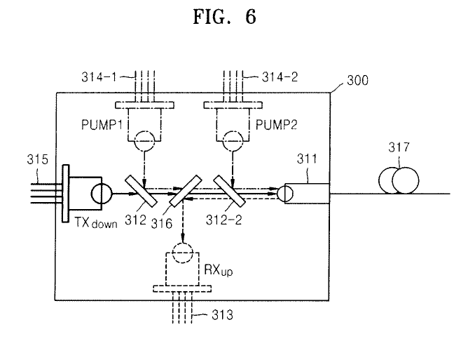

FIG. 6 is a diagram illustrating a transceiver module according to another embodiment of the present invention.

As shown in FIG. 6, two types of pump sources PUMP1 and PUMP2 are used to amplify received and transmitted optical signals using a gain medium of a transmission line.

A pump source and multiplexing or demultiplexing filters may be additionally integrated to amplify downstream and upstream optical signals at the same time.

As described above, according to the present invention, a pump source can be integrated with an optical transmission source or an optical receiver to amplify signals using a gain medium positioned at some point in an optical transmission line. Thus, a number of subscribers and a transmission distance can be increased. As a result, an economical optical subscriber network can be realized.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

The present invention provides a transceiver having a pump source and a single-unit integrated transceiver module using the transceiver.

1. A single-unit integrated transceiver having a pump source, comprising:
an optical transmitter converting an input electric signal into a downstream optical signal;
an optical receiver converting a received upstream optical signal into an electric signal;
the pump source amplifying the downstream or upstream optical signal using a gain medium positioned in an optical transmission line to amplify the input and output optical signals;
a convergence unit arranging or converging the downstream and upstream optical signals to/from the optical transmission line; and
a multiplexing and/or a demultiplexing filter, the multiplexing filter positioned on an optical path between the optical transmitter/pump source and the convergence unit, and multiplexing the downstream optical signal and the amplified optical signal to pass to the convergence unit, the demultiplexing filter positioned on an optical path between the convergence unit and the optical receiver and demultiplexing the upstream optical signal to pass to the optical receiver.

2. The single-unit integrated transceiver of claim 1, wherein the pump source comprises one or more light sources.

3. The single-unit integrated transceiver of claim 1, wherein the pump source is a light source using one of an EDF (erbium doped fiber), a (TDF) thulium doped fiber, Raman pumping amplification, and a PWA (planar waveguide amplifier) amplification methods.

4. The single-unit integrated transceiver of claim 1, wherein the gain medium is one of an EDF, a Raman optical fiber, and a PWA using a PLC (planar lightwave circuit) method.

5. The single-unit integrated transceiver of claim 4, wherein the gain medium is positioned in one of an OLT (optical line terminal) of an optical network terminal of an optical network, an allocator of a remote node, and an ONT (optical network terminal) of an ONU (optical network unit).

6. The single-unit integrated transceiver of claim 1, further comprising:
a first isolator preventing noise generated in the optical transmission line from being input to the optical transmitter; and
a second isolator preventing the noise from being input to the pump source.

7. The single-unit integrated transceiver of claim 1, wherein the optical receiver receives the upstream optical signal having a burst mode operation characteristic.

8. The single-unit integrated transceiver of claim 1, wherein the optical transmitter is a multi-channel light source simultaneously outputting a plurality of optical signals having different wavelengths.

9. The single-unit integrated transceiver of claim 1, further comprising:
a housing integrating the optical transmitter, the optical receiver, the pump source, the convergence unit, and the multiplexing and/or demultiplexing filter into a single-unit module.

10. The single-unit integrated transceiver module of claim 9, wherein the housing is of bulk type using a TO-CAN (Top Open Can) packaging.

11. The single-unit integrated transceiver module of claim 9, wherein the housing is a flat plate using a PLC platform.
